(19) United States
(12) Patent Application Publication
(10) Pub. No.: US 2005/0274442 A1
(43) Pub. Date: Dec. 15, 2005

(54) Wireless tire pressure and temperature monitoring system

(75) Inventors: Morris Huang, Taichung City (TW); John Young, Singang Township (TW)

Correspondence Address: DENNISON, SCHULTZ, DOUGHERTY & MACDONALD, 1727 KING STREET, SUITE 105, ALEXANDRIA, VA, 22314, US

(73) Assignee: ASIA PACIFIC MICROSYSTEMS, INC.

(21) Appl. No.: 10/866,025

(22) Filed: Jun. 14, 2004

(51) Int. Cl. B60C 23/10

(52) U.S. Cl. 152/415

(57) ABSTRACT

A wireless tire pressure and temperature monitoring system comprises a wireless monitor and transmitter unit installed on the wheel rim and a digital receiver and display unit equipped near the driver's seat. The wireless monitor and transmitter unit further includes a pressure sensor; a temperature sensor; a differential amplifier connected to the pressure sensor, an attenuator connected to the temperature sensor; a micro controller for calculating and processing the pressure signal received from the differential amplifier and the temperature signal received from the attenuator; a transmitter for transmitting the signals to the digital receiver and display unit via a filter and a resonant antenna so that the driver is able to be informed of the tire stability of the vehicle to assure traffic security. A centrifugal switch connected to the micro controller is actuated to start monitoring when the vehicle speed exceeds a defined range (10 km/hr˜20 km/hr), and stop monitoring after the vehicle speed drops down below the aforesaid range for about five minutes.

### BACKGROUND OF THE INVENTION

1. Field of the Invention

The present invention relates to a wireless tire pressure and temperature monitoring system, in particular, a wireless tire pressure and temperature monitoring system which can provide the vehicle driver with means for monitoring and controlling the state of vehicle tire pressure and temperature all the time during driving so as to ensure traffic security by preventing sudden and disastrous tire puncture.

2. Description of the Prior Art

To transport passengers to their destination quickly, comfortably, securely, and efficiently is the ultimate object of the vehicle as a traffic facility. Among these factors, the traffic security is the most important one. It not only depends on the driver's mentalities and prudence, but on the working condition of all mechanical parts of the vehicle such as tire and brake system, etc. Especially, the tire plays a very important role on traffic security for the vehicle. The appropriate tire pressure, fair tire temperature, and an optimistic surface condition of the tire, all contribute to assisting the vehicle to work securely and efficiently. An excessive tire pressure is known to counteract the advantage of reducing the rotational resistance against the road surface and exacerbating the abrasion of the tire on its crown face. Besides, excessive tire pressure will enlarge the surface tension of the tire resulting in vulnerable to external impact thus causing occurrence of cracking. On the other hand, an insufficient tire pressure brings about exaggerated consumption of the fuel due to increased rotational function and exacerbated abrasion on both side faces of the tire. In addition, the tire temperature rises up to deteriorate the tire or even causes to exfoliation of its shielding layer. From worse to worst, continuous operation of a tire with the above described situation is likely to fall into the most undesirable and dangerous result, that is, a traffic accident arising from a flat tire of sudden puncture when the vehicle is running with a high speed.

A patented case “Improved Tire Pressure Alarming Device” published by Taiwan Pat. No. 186905 in which an alarming device to detect tire pressure is inserted to the air valve of a tire, and each detecting unit has to include a detector and transmitter circuit and a power supply source. In this case, the installation cost will intensively increased for a large sized vehicle which has to equip a number of wheels. Further to this, the alarming device installed as such is apt to be tampered or stolen. Besides, it does not provide any tire temperature detecting unit. For these defects noticeable on the prior art, an improvement is seriously required.

The inventor has dedicated great efforts for years to studying and improving these defects and come up with a novel wireless tire pressure and temperature monitoring system as provided in this invention to eliminate defects mentioned above.

### SUMMARY OF THE INVENTION

It is the main object of the present invention to provide a wireless tire pressure and temperature monitoring system which is effective to monitor the present values of the vehicle tire pressure and temperature so as to remind the driver of the actual state of tire stability thereby serving to ensure the traffic security.

Another object of the present invention is to provide a wireless tire pressure and temperature monitoring system in which the monitoring system is installed on the outer edge of the steel or aluminum rim of a wheel firmly so as to perform monitoring precisely.

Another object of the present invention is to provide a wireless tire pressure and temperature monitoring system which can be produced with a low cost and installed easily yet securely without the fear of falling off the rotating tire or stolen from the parking vehicle.

For fuller understanding of the nature and objects of the invention, reference should be made to the following detailed description taken in conjunction with the accompanying drawings.

### BRIEF DESCRIPTION OF THE DRAWINGS

FIG. 1 is a schematic view of the present invention.

FIG. 2 is a block diagram showing the layout of the components included in the present invention.

FIG. 3 is a plane view of the digital receiver and display unit used in the present invention.

FIG. 4 is a perspective view of a housing in which the monitoring system of the present invention is accommodated.

FIG. 5 is a stop view of a wheel rim with a monitoring system of the present invention installed thereon.

FIG. 6 is a side profile view of a vehicle wheel with a housing accommodating the monitoring system of the present invention being installed on its rim.

### DETAILED DESCRIPTION OF THE PREFERRED EMBODIMENTS

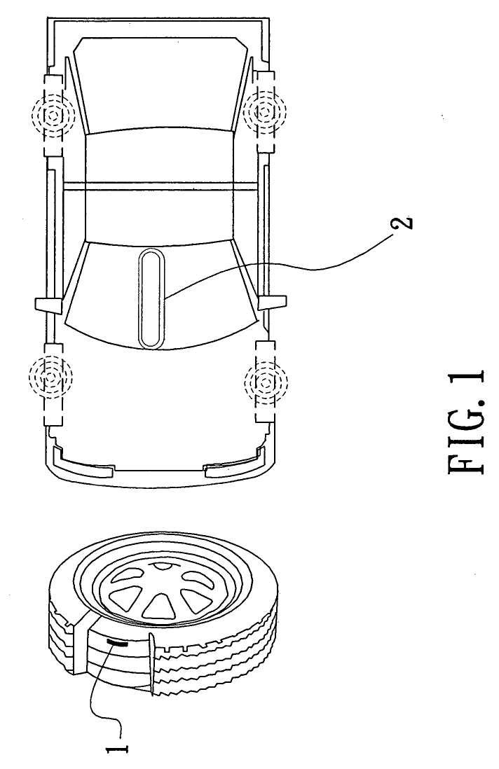

Referring to FIG. 1, in the schematic view of the present invention shown in FIG. 1, the wireless tire pressure and temperature monitoring system essentially comprises a wireless monitor and transmitter unit 1 installed on the steel wheel rim and a digital receiver and display unit 2 equipped near the driver's seat.

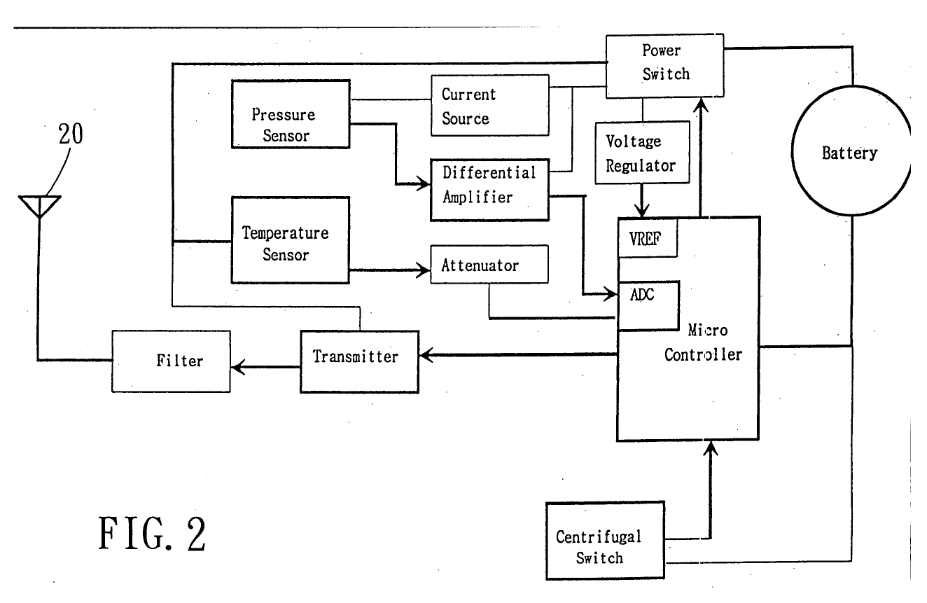

Referring to FIG. 2, in the block diagram of the present invention. The wireless monitor and transmitter unit 1 further includes: a pressure sensor for sensing the internal pressure of the tire; a temperature sensor for sensing the internal temperature of the tire; a differential amplifier connected to the pressure sensor for amplifying and transferring the signal received from the pressure sensor to a micro controller; an attenuator connected to the temperature sensor for transferring the signal received from the temperature sensor to the micro controller after being processed; the micro controller for calculating and processing the pressure signal received from the differential amplifier and the temperature signal received from the attenuator; a voltage regulator connected to the micro controller; a power supply switch connected with the micro controller and a power source (battery unit); the power source connected with the pressure sensor and the power supply switch; a centrifugal switch connected with the micro controller and the power source (battery unit) for automatically staring operation of the monitoring system in the case the vehicle speed reaches up to a defined range (for example, 10˜20 km/hr), or slows down lower than the above range for a defined time duration (for example, 5 minutes); a transmitter connected to the micro controller for transmitting the pressure and temperature signals after being processed by the micro controller; a filter connected to the transmitter for filtering the signal outputted from the transmitter; and an antenna 20 connected to the filter for transferring the pressure and temperature signals processed by the micro controller through the filter to the digital receiver and display unit 2 in resonance mode.

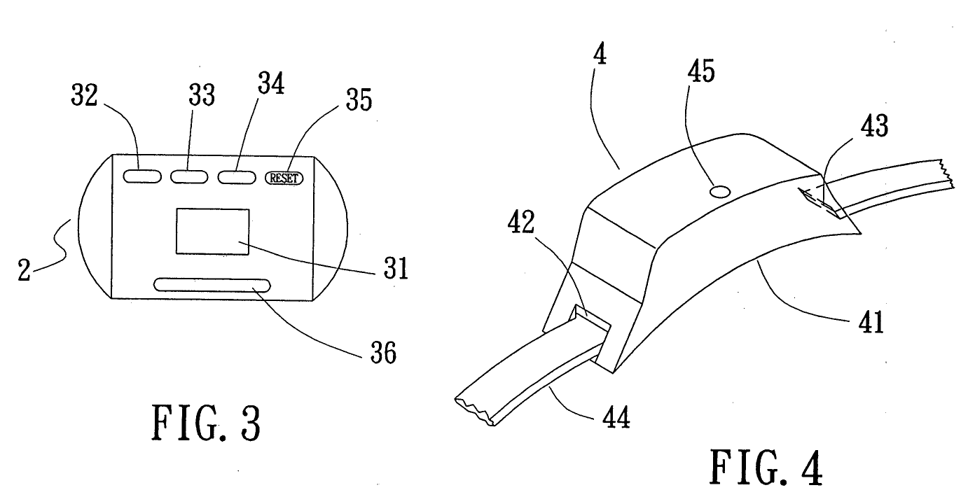

As show in FIG. 3, the digital receiver and display unit 2 includes a LCD surface board 31 on which equipped with a temperature display key 32, a pressure display key 33, a LCD back light key 34, a set key 35 and an alarm lamp 36 so as to display the pressure and temperature signals received from the antenna 20 on the LCD surface board 31 with the digital display mode, and turn on the alarm lamp in the case the tire pressure and temperature are abnormal.

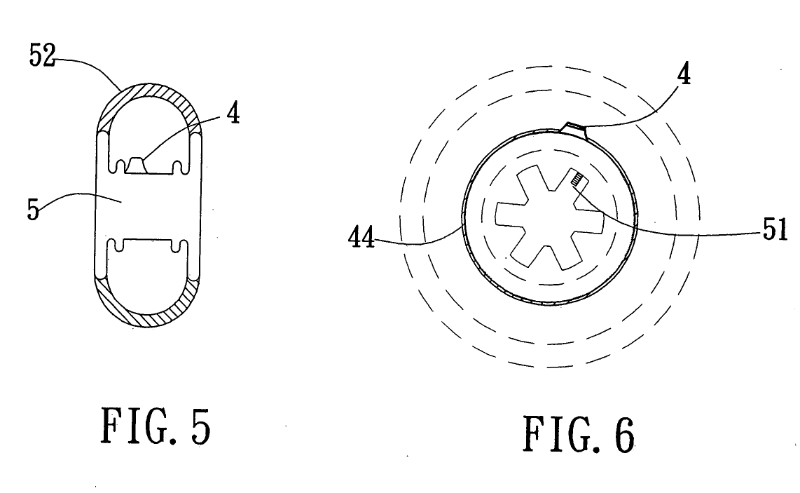

A housing 4 with its bottom surface 41 configurated into the same curvature as that of the wheel rim 5 is provided for accommodating the above described monitoring systems. Two drilled holes 42, 43 are formed each on one end of the housing 4 for passing through a steel belt 44 so as to bind the housing 4 on the outer edge of the wheel rim 5 nearby an air valve 51 of the tire as shown in FIGS. 5 and 6. With this structure, the tire pressure and temperature of a tire 52 can be measured through a ventilation hole 45 of the air valve 51.

Now operation of the wireless tire pressure and temperature monitoring system according to the present invention will be illustrated as follows:

The centrifugal switch of the monitoring system is actuated when the vehicle speed exceeds 10 km/hr to 20 km/hr.

At this moment the monitoring system is actuated to deliver a signal five times successively with a time interval of 40 seconds.

The tire pressure and temperature is measured once every 6 seconds during the vehicle is moving.

The instant signal of tire pressure and temperature is transferred to the digital receiver and display unit equipped near the driver's seat every 5 to 10 minutes for five times during the vehicle is moving.

Abnormal state of the tire pressure and temperature will be reported instantly by delivering ten times of signals with a time interval of about 40 seconds between two successive signals, and the aforesaid action will be repeated every five minutes.

The centrifugal switch will switch off the monitoring system to restore standby mode after the vehicle stops for longer than five minutes so as to save consumption of electricity thereby maintaining the durability of the battery unit.

From the above description, it is understood that he present invention has several advantages that by stowing the monitoring system in a housing which is secured to the outer edge of a wheel firmly so as to measure the tire pressure and temperature precisely from time to time during the vehicle is moving thereby reminding the driver of the actual state of tire stability and serving to ensure the traffic security. Besides, this monitoring system can be produced with a low cost and installed easily yet securely without the fear of failing off accidentally or stolen from the parking vehicle.

Although the description above contains many specificities, these should not be construed as limiting the scope of the invention but as merely providing illustration of some of the presently preferred embodiment of this invention. Thus the scope of the invention should be determined by the appended claims and their legal equivalents, rather than by the examples given.

1. A wireless tire pressure and temperature monitoring system essentially comprising a wireless monitor and transmitter unit installed on the wheel rim and a digital receiver and display unit, wherein said wireless monitor and transmitter unit detects the tire pressure and temperature and transfers the data to said digital receiver and display unit for display through a resonance type antenna so as to inform the driver about the present state of the tire stability thereby assuring traffic security.

2. The wireless tire pressure and temperature monitoring system of claim 1, wherein said wireless monitor and transmitter unit further includes: a pressure sensor for sensing the internal pressure of the tire; a temperature sensor for sensing the internal temperature of the tire; a differential amplifier connected to said pressure sensor for amplifying and transferring the signal received from said pressure sensor to a micro controller; an attenuator connected to said temperature sensor for transferring the signal received from said temperature sensor to said micro controller after being processed; said micro controller for calculating and processing the pressure signal received from said differential amplifier and the temperature signal received from said attenuator; a voltage regulator connected to said micro controller; a power supply switch controlled by the micro controller and a power source (battery unit) connected; said power source connected with said pressure sensor and said power supply switch; a centrifugal switch connected with said micro controller and said power source (batter unit) for automatically starting operation of said monitoring system in the case the vehicle speed reaches up to a defined range, or slows down lower than the above range for a defined time duration; a transmitter connected to said micro controller and power Supply through power switch for transmitting the pressure and temperature signals after being processed by said micro controller; a filter connected to said transmitter for filtering the signal outputted from said transmitter; and an antenna connected to said filter for transferring the pressure and temperature signals processed by said micro controller through said filter to said digital receiver and display unit in resonance mode.

3. The wireless tire pressure and temperature monitoring system of claim 1, wherein said digital receiver and display unit includes a LCD surface board on which equipped with a temperature display key, a pressure display key, a LCD back light key, a set key and an alarm lamp so as to display the pressure and temperature signals received from said antenna on said LCD surface board in the digital display mode, and turn on said alarm lamp in the case the tire pressure and temperature are abnormal.

4. The wireless tire pressure and temperature monitoring system of claim 1, wherein a housing with its bottom surface configurated into the same curvature as that of the wheel rim is provided for accommodating said monitoring system, two drilled holes are provided each on one end of said housing for passing through a steel belt so as to bind said housing on the outer edge of said wheel rim nearby the air valve of the tire, the tire pressure and temperature is measured through a ventilation hole on said air valve.
